(19) United States
(12) Patent Application Publication
(10) Pub. No.: US 2026/0338015 A1
(43) Pub. Date: Oct. 29, 2026

(54) Indexing Plunger

(71) Applicant: Otto Ganter GmbH & Co. KG Normteilefabrik, Furtwangen (DE)

(72) Inventor: Patrick ROMBACH, Furtwangen (DE)

(21) Appl. No.: 19/648,574

(22) Filed: Apr. 15, 2026

(30) Foreign Application Priority Data
Apr. 24, 2025 (EP) 25172419.1

(51) Int. Cl. E05C 1/04; E05C 1/00; G01D 5/14

(52) U.S. Cl. CPC E05C 1/04; E05C 1/002; G01D 5/14; G01D 2205/18

(57) ABSTRACT

An indexing plunger with a cylindrical pin guide, in which an axially displaceable pin with a locking end and an actuating end is mounted, wherein the pin is displaceable between two axial end positions and is connected to the actuating element, wherein at least one sensor is fastened to the pin guide, which detects the end positions of the pin by means of at least one magnet connected to the pin and generates a signal which can be further processed, wherein the magnet is located in the interior of the pin guide and bears against a shoulder on the outer circumference of the pin and is movable with the pin in the axial direction, wherein the magnet is mounted so as to be axially displaceable along the shaft of the pin.

The object of the invention is an indexing plunger according to the preamble of claim 1.

A manually operated indexing plunger is disclosed, for example, in DE 10 2012 112 610 A1 and consists of a sleeve and a pin mounted in the sleeve, which has a locking end and an actuating end. The pin is axially displaceable within the sleeve and can be moved between a first and a second axial end position.

The pin can engage with a latching mechanism at least in an axial end position relative to the sleeve and thus be fixed temporarily or permanently. In addition, the indexing plunger can have an automatic reset and thus assume a home position.

Whether the indexing plunger is moved for actuation or for locking or unlocking by pushing or pulling the actuating element, for example a knob, depends on the installation location of the resetting element, e.g., a compression or tension spring.

One disadvantage of this indexing plunger is that it is not possible to determine the position of the pin without a visual inspection. However, if the indexing plunger is used to fix a component, such as a flap on a machine housing, for example, it is necessary to ensure that the indexing plunger is in its axial locked position or that said position is released. This is the only way to ensure that the component is securely locked or unlocked.

However, with prior art indexing plungers, it is only possible to detect the position of the indexing plunger by visual perception.

Even if the pin appears to be in its locked position or the view of the pin is obscured by another component, it is not possible to determine from a remote viewpoint whether the indexing plunger is actually engaged and fixed in its locked position. For example, the indexing plunger could be released from its locked or unlocked position by vibration without this being noticed.

EP 3 527 760 B 1 discloses an indexing plunger with a cylindrical pin guide in which an axially displaceable pin with a locking end and an actuating end is mounted. The pin can be moved between two axial end positions and has an actuating element. At least one sensor is attached to the pin guide, which detects the end positions of the pin by means of a magnet connected to the pin and generates a signal that can be processed further. The magnet is located in the interior of the pin guide and is connected to a shoulder on the outer circumference of the pin, wherein it encloses it in an annular or segment-like manner.

The interior of the pin guide is directly linked to the stroke of the pin. To enable a greater stroke, the internal space must be enlarged, as the magnet connected to the pin travels a greater distance. This leads to an increase in the space required for the entire indexing plunger.

However, particularly in safety-relevant applications, such as those required in large systems, the indexing plunger must be actuated over a greater distance, wherein the disengaged position of the pin must be precisely determined and monitored.

The task of the present invention is to further develop an indexing plunger of the known type in such a way that the interior of the pin guide is optimized independently of the stroke of the pin, without impairing the functionality of the system—in particular the precise detection of the end positions of the pin by the magnet.

In accordance with the invention, the task is solved by the features of the independent patent claim, while advantageous embodiments and
further developments of the invention can be gathered from the sub-claims

An advantageous feature is that the magnet is axially displaceable along the shaft of the pin.

This means that the magnet enters the detection range of the sensor with a travel delay when the pin is pulled. When the pin is pulled, the magnet enters the detection range of the sensor with a delay due to a travel delay. The switching request only occurs when the magnet reaches a certain position, regardless of the speed of the pin pull. This ensures that the sensor only reacts at a defined distance, which enables precise detection of the end position.

A shoulder on the shaft of the pin only carries the magnet in the direction of the second axial end position from a region above the center between the first axial end position or the second axial end position.

With an exemplary stroke of 10 mm, a movement of the preferably annular magnet of only 3 to 4 mm is sufficient to detect magnetic damping. The magnet body is not firmly connected to the pin, but is only carried along by the pin in the axial direction towards the end of the stroke. For this purpose, the central pin has a radial shoulder on which the preferably annular or circular magnet rests as soon as the indexing plunger has already been lifted a certain distance.

In contrast to a stationary magnet, as is known from the state of the art, the magnet is only carried along at the “end” of the stroke path and only as far as is necessary for signal generation. A larger stroke is not necessary with this design.

The lifting force acts on the magnet against a spiral spring, which is described later in its function as a return spring. The magnet does not have to be completely covered by the sensor ring; approaching it is enough to generate a signal. The sensor thus reacts to the magnetic proximity in order to trigger a switching request. However, it is important that the magnet covers a certain minimum distance, which depends on the size of the component, in order to generate a measurable signal. This minimum distance ensures that the magnet reaches the region of the sensor sufficiently so that the position of the pin can be clearly and reliably detected.

A further feature of the invention is the two-part housing, in which the housing halves are connected to one another via a joint seat. This offers advantages with regard to the pin guide and enables particularly easy integration of the magnet when mounting the pin guide, which leads to an optimization of the installation space.

The pin guide in the area of the cavity in which the magnet is movably mounted is designed as a two-part assembly and consists of an upper and a lower housing. These two housing parts can be joined together using a threaded connection, a press fit or laser welding, for example.

In a further embodiment, the pin can be held in one or both end positions by latching mechanisms, friction or adhesion.

Instead of a latching query, a disengagement query is protected in this invention. This means that the disengaged state is detected by a signal, e.g., using a magnet-based sensor.

The advantage of this solution is that the detection can be evaluated as a high signal. This means that the status is only considered to have been reached if a high signal is detected. In contrast to the state of the art, where only the absence of a signal is sufficient as a criterion for position detection, this solution offers a more reliable way of monitoring. Not only the end position, but also a potential deviation, such as an unintentional disengagement of the pin, can be detected at an early stage. This invention thus enables more precise monitoring of the position and ensures that “positive” feedback is always given, regardless of whether communication is via radio or cable.

The magnet is mounted in a cavity of the pin guide, which is bounded by a step in the direction of the first axial end position facing the actuating end and by a second step in the direction of the second axial end position facing the locking end. The pin is guided through a recess between the steps.

A spring is clamped between the upper side of the magnet and the step, which serves as a return spring. In a further embodiment, such a return spring can be dispensed with in a vertical installation position, wherein the magnet falls back into its initial position on the lower step due to gravity.

The cavity consists of an upper chamber facing the actuating end and a lower chamber facing the locking end. The upper chamber is smaller in diameter than the lower chamber and the transition between the two chambers is formed by a step.

When the magnet moves, it comes to rest against this step in the first axial end position facing the actuating end.

In the second axial end position, facing the locking end, the magnet comes into contact with the other step.

The magnet can be either axially or diametrically magnetized, although other magnetization directions, such as radial or tangential magnetization, can also be implemented. It is also possible to use multipole magnets, which have several magnetic poles and thus influence the magnetic field distribution. When the actuating knob is actuated to move the pin axially in the pin guide, the ring magnet is moved relative to a sensor mounted in the region of the pin guide.

The magnet surrounds the pin in an annular or segment-like manner. However, the magnet can also have an oval or polygonal shape, wherein the shape is preferably adapted to the inner circumference of the guide channel. The magnet used can be a neodymium or ferrite magnet, for example, or be made of another magnetic material. For the standardized installation of sensors, it is necessary that the magnets are manufactured precisely to ensure consistent and reproducible switching distances. Alternatively, magnets with inhomogeneous magnetic fields, varying material quality and tolerances in the field strength can also be used, wherein the accuracy of the switching distances may be impaired in this case, but the quality of the signal still remains sufficient in many applications, or one or more required compensation or offset factors can be determined by suitable, iterative adjustment or teaching processes, the application of which can compensate for the insufficient switching precision caused by quality

An essential feature of the invention is thus the use of an indexing plunger with a position query which makes it possible to determine whether the indexing plunger is engaged and/or disengaged or locked and/or unlocked. The sensor detects either the front (locked position) or the rear end position (unlocked position) or both positions of the pin. For this purpose, at least one sensor is attached to the pin guide, which detects the two axial end positions of the pin as a measured variable and generates a signal that can be further processed, which is hydraulic, pneumatic or preferably electrical.

To detect the position of a pin moving in a pin guide, a sensor is used that recognizes this position and converts it into a measurement signal. Such a sensor reacts either contact-free to the approach of an object, i.e., without direct contact.

The present invention claims the use of the following exemplary proximity sensors and linear displacement sensors:

Inductive sensors: These react to both ferromagnetic and non-magnetic metallic objects.

Capacitive sensors: These react to metallic and non-metallic materials. When an object approaches, the oscillation frequency of the oscillating circuit of the sensor changes.

Magnetic sensors (e.g., reed switches, reed contacts or Hall sensors): These react to a magnetic field.

Alternatively, a mechanical or tactile limit switch can also be used, which supplies an evaluable signal by pneumatic, hydraulic or electronic means.

Furthermore, the position can also be recorded using RFID (Radio Frequency Identification) or NFC (Near Field Communication) technology, wherein the sensor is replaced by a transponder. In this case, the corresponding antenna is located in the actuating knob of the movable pin.

The invention is described below with reference to a type of magnetic sensor that reacts to a magnetic field. In a first embodiment, a permanent magnet is attached to the moving part of the indexing plunger. Depending on the position of the indexing plunger, the magnet is at different distances from the respective sensor. The advantage of a magnetic sensor is that it works reliably even under difficult conditions, such as heat, dust and vibrations, as well as through non-ferromagnetic objects.

An actuating element for actuating the pin can be designed as an actuating knob, for example. However, the present invention is not limited to this design as an actuating knob; a lever, a latch, a T-handle or any other actuating element-with or without a handle-is also covered by the invention.

The sensor is positioned below the contact surface on which the underside of the actuating knob rests in the locked position of the indexing plunger. It is embedded in a sensor holder that at least partially surrounds the pin guide in an annular manner. If the sensor detects the magnetic field of the ring magnet and this exceeds a certain threshold value, the sensor emits a signal that indicates the unlocked position of the pin. Even the approach or distancing of the ring magnet from the sensor can be detected by the sensor.

The sensor can be programmed during the production of the component so that, for example, a threshold value of 2-6 millitesla must be exceeded before the sensor emits a signal.

The sensor is attached to the pin guide—whether detachable or non-detachable—by positive, frictional or non-positive engagement. This can be done by snapping on, clamping, plugging on, screwing in or using an additional sensor holder on the component.

In a further embodiment of the invention, it is provided that a sensor holder is dispensed with and the sensor is accommodated directly in the sheath of the pin guide. For this purpose, a receiving hole or similar recess is made in the pin guide into which the sensor can be inserted in order to detect the position of the pin.

The receiving space for the sensor can also be cast directly into the component, for example.

The device according to the invention is suitable for pins with or without a detent lock. A detent lock is used to fix the actuating knob in a specific end position. If the pin is pulled out of the pin guide, the underside of the actuating knob can be supported on the end face of a sleeve-shaped detent lock, which is referred to below as a detent sleeve.

The actuating knob has at least one shoulder on its underside, which interrupts the cylindrical receiving space inside the hollow actuating knob in sections. This receiving space is used to accommodate the detent sleeve when the underside of the actuating knob rests on the contact surface and the indexing plunger is in the locked position.

The position of the actuating knob in which the shoulder rests on the detent sleeve can only be reached by turning the knob. The shoulder is rotated until it reaches an axial notch in the wall of the detent sleeve and engages in it. In this position, the indexing plunger can remain in the end position reached either temporarily or permanently, wherein changes to the position in the axial direction are not possible.

If the shoulder is turned again until it reaches an axial slot in the wall of the detent sleeve and is accommodated there, the actuating knob with the shoulder can be moved back towards the front contact surface of the pin guide.

The reverse operating principle of the indexing plunger according to the invention is also possible, in which actuation by pushing rather than pulling is required. In this case, a spring element is preferably provided which presses the pin into an axial end position.

The object of the present invention results not only from the content of the individual patent claims, but also from their combination with one another.

All information and features disclosed in the documents, including the abstract—in particular the spatial configuration shown in the drawings—are claimed to be essential to the invention insofar as they are new, either individually or in combination, compared with the prior art.

Insofar as individual items are designated as “essential to the invention” or “important”, this does not necessarily mean that these items must form the object of an independent claim. This results solely from the respective applicable version of the independent patent claim.

The invention is explained in more detail below with reference to a plurality of drawings depicting the embodiments. The drawings and their description show further features and advantages of the invention which are essential to the invention.

The figures show:

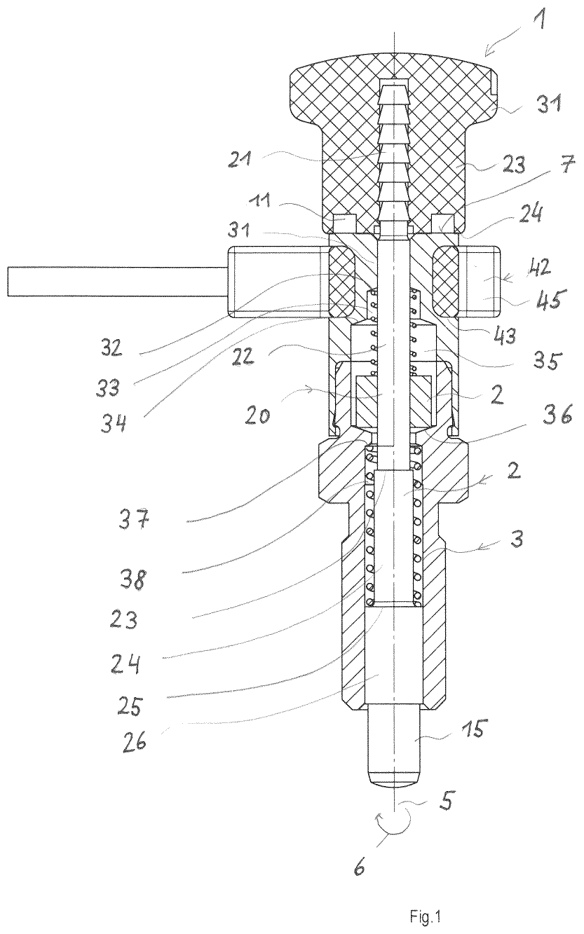

FIG. 1: a sectional depiction of an indexing plunger

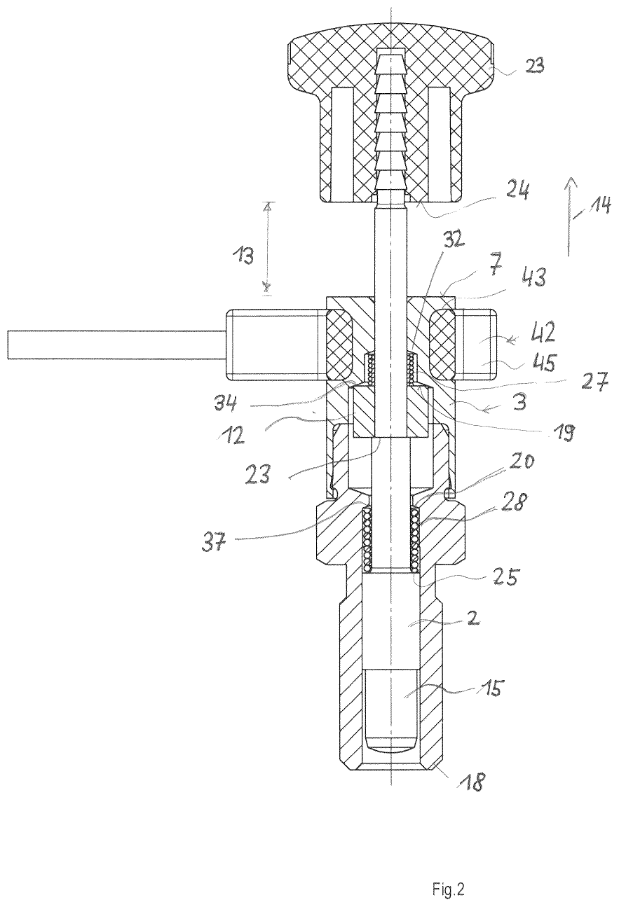

FIG. 2: a sectional depiction of the indexing plunger

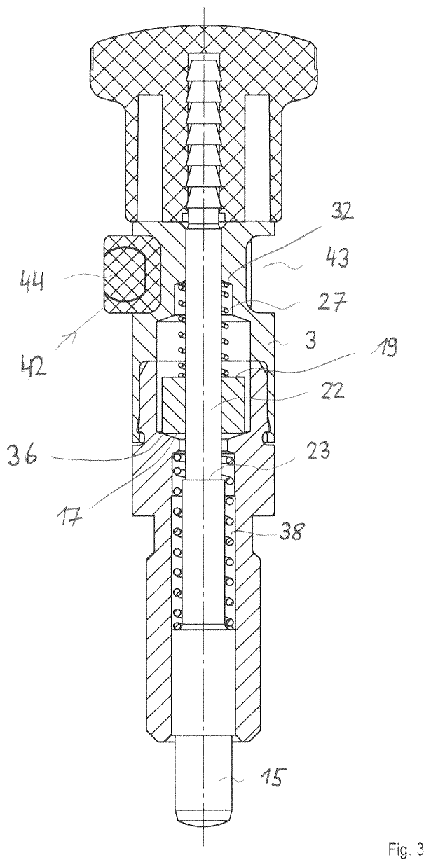

FIG. 3: a sectional depiction of the indexing plunger rotated by 90° compared to FIGS. 1 and 2

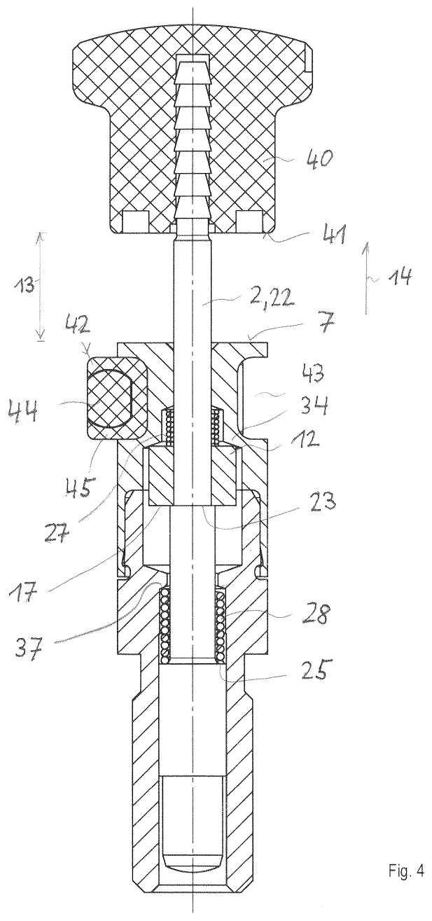

FIG. 4: a sectional depiction of the indexing plunger rotated by 90° compared to FIGS. 1 and 2

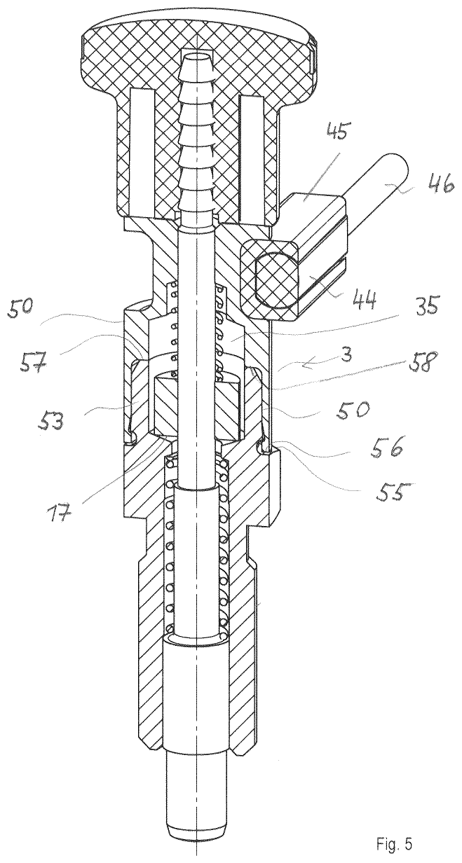

FIG. 5: a perspective sectional depiction of the indexing plunger

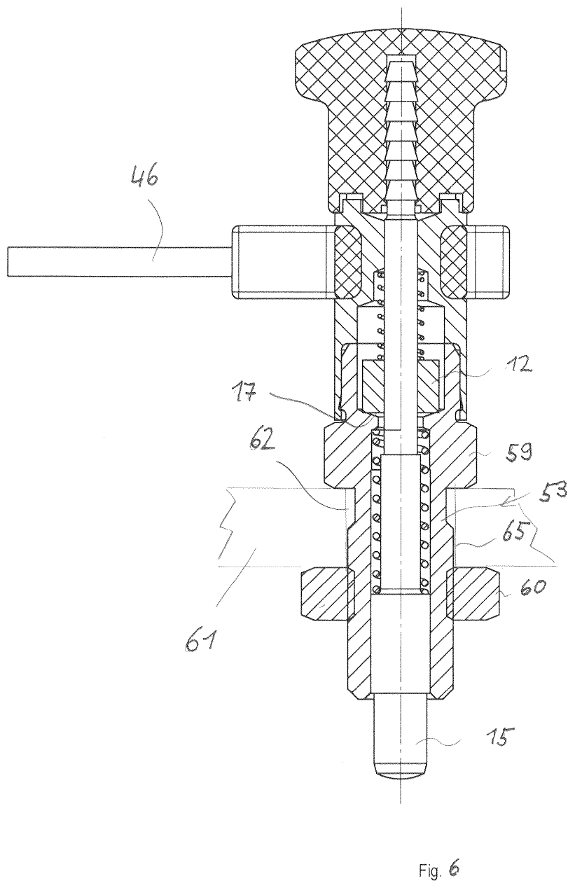

FIG. 6: a sectional depiction of a mounted indexing plunger

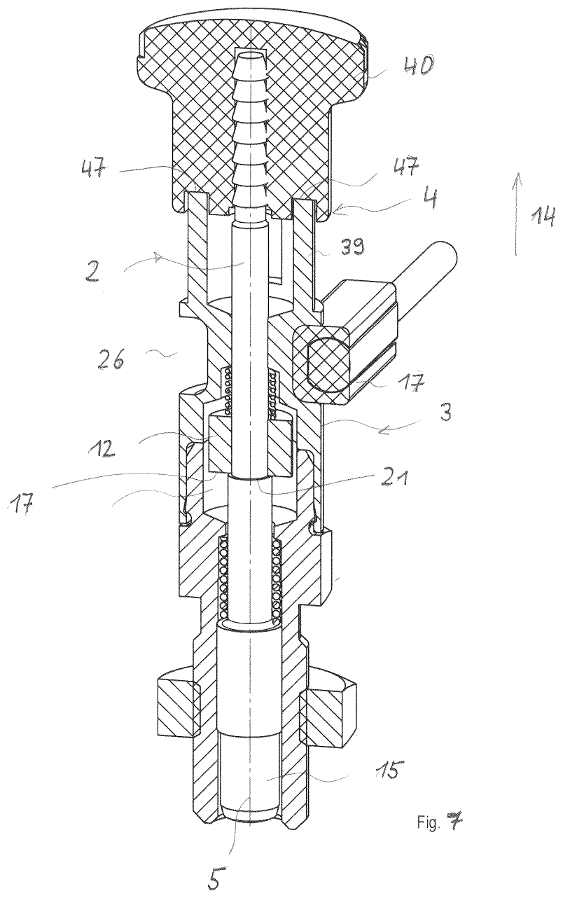

FIG. 7: a sectional depiction of an indexing plunger with detent lock

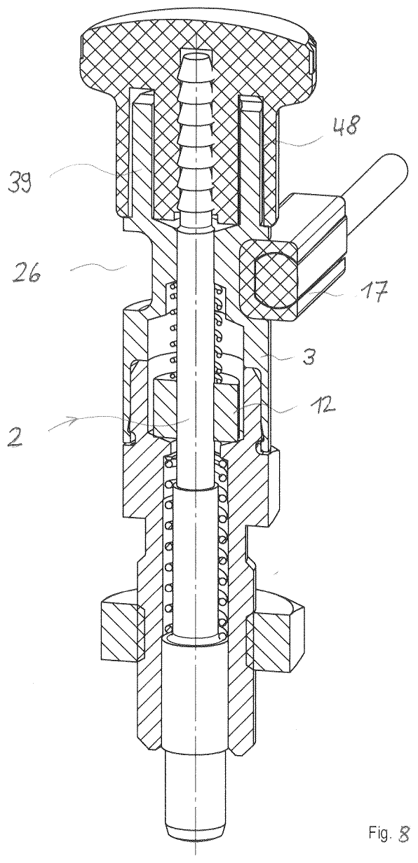

FIG. 8: a sectional depiction of an indexing plunger with detent lock

FIG. 1 shows an indexing plunger 1, which comprises a pin 2 that is guided in an axial direction in a pin guide 3. The pin 2 moves along an axis 5 and can also be rotated about this axis in the direction of rotation 6.

The pin 2 has a locking end 15 and an actuating end 16, which is equipped with an actuating knob 40 in FIG. 1. However, the present invention is not limited to the use of an actuating knob; alternatively, a lever, a latch, a T-handle or another actuating element can also be used.

The pin 2 can be moved axially along the axis 5 in the pin guide 3 via the actuating knob 40 and rotated about this axis in the direction of rotation 6.

The actuating knob 40 has an underside 41, which is located opposite a contact surface 7 on the end face of the pin guide 3. In the example shown in FIG. 1, the underside 41 rests on the contact surface 7.

The pin guide 3 has a groove 43 below the contact surface 7, into which a sensor element 42 is inserted. In the example shown in FIG. 1, the sensor element 42 is integrated into the wall of the pin guide 3 in the shape of a ring. The sensor element 42 comprises a sensor holder 45 and at least one sensor 44.

The sensor 44 can, for example, be injected into a plastic sensor holder 45. A sensor holder 45 made of plastic is generally preferred.

In addition to the variant of the sensor 44 injected into the sensor holder 45, the sensor 44 can also be attached by insertion into the sensor holder 45.

In the example shown in FIG. 1, the sensor element 42 is held in the groove 43 by clamping force. This clamping force is created by the horseshoe-shaped geometry of the sensor element 42, which is pushed onto the pin guide 3 in the region of the ring-shaped groove 43. However, the invention is not limited to this horseshoe or U-shape of the sensor holder; a circular segment-shaped enclosure is also possible.

The pin guide 3 has a guide channel 30 in which the pin 2 is movably guided. The guide channel 30 has a plurality of cylindrical sections with different diameters, which will be discussed in more detail later.

Inside the pin guide 3, the pin 2 is enclosed in sections by a ring-shaped magnet 12.

The pin 2 has a shaft 20 with several sections of different diameters. The section 21 of the shaft 20 is friction-locked in the actuating knob 40 at the actuating end. Directly below the actuating knob 40 is a further section 22, which in the example shown in FIG. 1 is guided through a cylindrical pin guide 31. This pin guide 31 opens into a chamber 33, which has a larger diameter than the pin guide 31. There is a step 32 between the pin guide 31 and the chamber 33.

Chamber 33 merges into a further chamber 35, the diameter of which is larger than that of chamber 33. The transition between chamber 33 and chamber 35 is defined by a step 34. The chamber 35 is limited in the direction of the locking end 15 by a step 36, wherein there is only a central recess for guiding the shaft 20 of the pin 2. Below this recess is chamber 38, which has a smaller diameter than chamber 35. Here is another step 37. The chamber 38 extends cylindrically to the end of the pin guide 3.

In the state according to FIG. 1, the section 22 of the shaft 20 extends through the pin guide 31, the chamber 33 and the chamber 35 and joins the chamber 38. There it merges into section 24, which has a larger diameter than section 22. The transition between section 22 and section 24 is defined by a shoulder 23. Section 24 continues into section 26 in chamber 38, which in turn has a larger diameter than section 24. The connection between section 24 and section 26 is formed by shoulder 25. Section 26 finally merges into the locking end 15, which is also cylindrical.

FIG. 2: If the actuating knob 40 is moved together with the magnet 12 in the arrow direction 14 towards the stop surface 9, the sensor 44 detects this approach as a measured variable and converts it into an electrical, pneumatic or hydraulic signal that can be further processed. In particular, this allows the distance between the underside 41 of the actuating knob 40 and the contact surface 7 of the pin guide 3 to be determined and monitored.

FIG. 2 shows the unlocked position of the invention. This is brought about by pulling the actuating knob 40 or the actuating element. This pulls the pin 2 into the pin guide 3 so that the locking end 15 is pulled back into the open end face 18 of the pin guide 3 and assumes the unlocked position.

The spring 28, which rests on the shoulder 25 of the pin 2, is compressed between the shoulder 25 and the step 37 inside the pin guide 3. In this position, the underside 41 of the actuating knob 40 is at a defined distance 13 from the contact surface 7 of the pin guide 3.

The sensor 44 detects the approaching magnet 12 and sends a corresponding signal. The magnet 12 consists at least partially of a magnetic material. Such a material can be integrated into the production process of the magnet 12 by injection molding, for example. Alternatively, the magnet can be produced in a sintering process in which the magnetic particles are compressed under pressure.

The magnet 12 has an upper side 19 in the direction of the actuating end 16, on which one side of the spring 27 rests. The opposite side of the spring 27 is supported by the step 32. In the unlocked position depicted in FIG. 2, the spring 27 clamped between the upper side 19 and the step 32 is compressed. At least the edge regions of the upper side 19 are in contact with the step 34.

FIG. 3 shows a view rotated by 90° compared to FIGS. 1 and 2, with the sensor element 42 arranged with the clamp-shaped sensor holder in the groove 43. This groove is located in the upper region of the sleeve-like pin guide 3. The sensor 44 is integrated decentrally in the sensor holder 45.

The sensor holder 45 has a receiving hole into which the sensor 44 can be inserted. Fixation can be achieved, for example, by axial insertion or attachment or by a detachable or permanently latching closure, for example by means of a cable tie.

The magnet 12 for determining the position of the pin 2 loosely surrounds the outer circumference of the section 22 and rests with its underside 17 at least partially on the step 36. The shoulder 23 is not in contact with the magnet 12 and is located inside the chamber 38.

The spring 27, which is supported above on the step 32, acts on the upper side 19 of the magnet 12. The spring presses the magnet 12 onto the step 36 when the indexing plunger is in the locked position and the locking end 15 is extended.

In FIG. 4, the actuating knob 40 is pulled in the arrow direction 14, so that a distance 13 is created between the underside 41 and the contact surface 7. The pin 2 partially protrudes with its section 22 out of the pin guide 3. Via its shoulder 23, the pin 2 also carries the magnet 12 in the axial direction in the arrow direction 14 until its upper side 19 abuts against the step 34.

If the magnet 12 is thus guided in the direction of the sensor 44, said sensor detects the position of the magnet and can recognize the momentary or unlocked or retracted position of the pin 2.

A spring 27, 28 is compressed between the upper side 19 and the step 32 as well as between the shoulder 25 and the step 37.

FIG. 5 shows a perspective sectional depiction of FIG. 3. The sensor holder 45 is connected to a cable 46, which leads to a signal processing device not shown.

The pin guide 3 is designed as a two-part assembly and can be separated in the area of the magnet 12. It consists of an upper housing 50 and a lower housing 52, which are screwed together via a threaded connection 54 consisting of an external thread and an internal thread.

In further embodiments, this connection can be formed by a press fit or laser welding, for example.

The upper housing 50 has an integral, homogeneous sleeve 51 whose wall thickness is reduced radially outwards from a defined step 58.

The lower housing 52 also has an integral sleeve 53, the wall thickness of which is reduced radially inwards in the region of the threaded connection 54. This reduction in wall thickness begins at an extension 55.

In the assembled state, the end face 56 of the sleeve 51 rests on this extension 55, while the end face 57 of the sleeve 53 rests on the step 58. Ideally, there is direct contact between the end faces, but material-related manufacturing tolerances can mean that there is no complete abutting contact. Regardless of this, the threaded connection 54 guarantees the required mechanical strength.

As the pin guide 3 can be divided in the region of the threaded connection 54, it is possible to access the magnet 12. This allows the magnet 12 together with the spring 27 to be pushed onto the shaft 20 before the sleeve 51 is screwed to the sleeve 53. This creates a chamber 35 in which the magnet 12 is movably mounted.

FIG. 6 shows a threaded ring 60, which has an internal thread and can be screwed onto the external thread 63 of the sleeve 53. The external thread 63 is located in the section of the sleeve 53 facing the actuating end.

The indexing plunger 1 can be inserted through a through hole 62 in the plate 61 until the mounting collar 59 rests on the upper side of the plate 61. The threaded ring 60 is then screwed onto the external thread 63 of the indexing plunger from the underside until it rests against the underside of the plate 61. This secures the indexing plunger 1 to the plate 61 by friction locking. To make assembly easier, the threaded ring and/or the mounting collar can have a tool contact surface, for example in the form of a hexagon.

FIG. 7: In this embodiment, the indexing plunger 1 has a detent lock to temporarily or permanently fix the actuating knob 40 in a defined end position (unlocked position).

When the pin 2 is pulled out of the pin guide 3 in the arrow direction 14, the actuating knob 40 can rest with its underside 41 on the end face of the detent sleeve 39. For this purpose, the actuating knob has a groove-shaped shoulder 47 against which the end face of the detent sleeve 39 comes to rest. Preferably, two shoulders 47 are arranged on a circular path.

The shoulder 47 interrupts the cylindrical receiving space 48 in sections. The receiving space 48 serves to receive the detent sleeve 39 when the underside of the actuating knob 40 is located on the contact surface 7, as depicted in FIG. 1, for example.

The position of the actuating knob 40 shown in FIG. 7, which rests on the detent sleeve 39, can only be released by moving the knob 40 along the axis 5 in the arrow direction 14 and by a subsequent rotary movement about this axis.

As soon as the shoulder 47 is no longer in contact with the end face of the detent sleeve 39, the knob 40 can be rotated about the axis 5, e.g., by 90°, until the shoulder 47 reaches a slot in the wall of the detent sleeve 39. The slot accommodates the shoulder 47 so that the detent sleeve 39 can be inserted into the receiving space 48.

This allows the actuating knob 40 to be moved again in the opposite arrow direction 14 towards the front contact surface 7 of the pin guide 3.

The indexing plunger is queried when approaching or reaching the position shown in FIG. 7 (or 2, 4), i.e., in the disengaged state. In this position, the actuating end 15 is retracted into the pin guide 3.

In the example depicted in FIG. 7, the underside 41 of the actuating knob 40 is at a defined distance 13 from the contact surface 7 of the pin guide 3. The spring 28, which rests on the shoulder 25 of the pin 2, is compressed between the ring shoulder and a step 37 inside the pin guide 3.

FIG. 8 shows a sectional view of the indexing plunger. In this position, the slot in the wall of the detent sleeve 39 has received the shoulder 47 of the actuating knob 40, and the detent sleeve 39 is inserted into the receiving space 48. The sensor 44 used here is a magnetic field sensor.

If the magnet 12 is now guided in the direction of the sensor element 42, said sensor detects the position of the magnet and can determine the momentary unlocked or retracted/disengaged position of the pin 2.

The position of the actuating knob 40 shown in FIG. 7, in which the groove-shaped shoulder 47 rests on the detent sleeve 39, can only be released by moving the knob 40 along the axis 5 in the opposite arrow direction 14. As soon as the shoulder 47 is no longer in contact with the end face of the detent sleeve 39, the knob 40 can be rotated about the axis 5 until the shoulder 47 reaches a slot in the wall of the detent sleeve 39. The slot accommodates the shoulder 47 so that the detent sleeve 39 can be inserted into the receiving space 48. Springs 27 and 28, which act as return springs, provide support.

The actuating knob 40 can thus be moved against the arrow direction 14 in the direction of the front contact surface 7 of the pin guide 3 until it reaches the end position according to FIG. 8.

The present invention also claims indexing plungers without the detent lock depicted in the figures.

### DRAWING LEGEND

1 indexing plunger
2 pin
3 pin guide
4 detent lock
5 axis
6 direction of rotation
7 contact surface
8
9 stop surface
10 floor surface
11
12 magnet
13 distance
14 arrow direction
15 locking end
16 actuating end
17 sensor element
18 end face
19 upper side (of 12)
20 shaft (of 2)
21 section
22 section
23 shoulder
24 section
25 shoulder
26
27 spring
28 spring
29
30 guide channel
31 pin guide
32 step
34 step
35 chamber
36 step
37 step
38 chamber
39 detent sleeve
40 actuating knob
41 underside
42 sensor element
43 groove
44 sensor
45 sensor holder
46 cable
47 shoulder
48 receiving space
49
50 housing
51 sleeve
52 housing
53 sleeve
54 threaded connection
55 extension
56 end face (of 51)
57 end face (of 53)
58 step
59 mounting collar
60 threaded ring
61 plate
62 through hole
63 external thread (of 53)

1. An indexing plunger with a cylindrical pin guide, in which an axially displaceable pin with a locking end and an actuating end is mounted, wherein the pin is displaceable between two axial end positions and is connected to the actuating element, wherein at least one sensor is fastened to the pin guide, which detects the end positions of the pin by means of at least one magnet connected to the pin and generates a signal which can be further processed, wherein the magnet is located in the interior of the pin guide and bears against a shoulder on the outer circumference of the pin and is movable with said pin in the axial direction, wherein the magnet is mounted so as to be axially displaceable along the shaft of the pin.

2. The indexing plunger according to claim 1, wherein the magnet enters the detection range of the sensor with a travel delay when the pin is pulled.

3. The indexing plunger according to claim 1, wherein the shoulder only carries the magnet in the direction of the second axial end position from the center between the first axial end position or the second axial end position.

4. The indexing plunger according to claim 1, wherein the magnet is mounted in a cavity of the pin guide which cavity is bounded by a step in the direction of the first axial end position facing the actuating end and by a second step in the direction of the second axial end position facing the locking end, and in that the pin is guided through a respective recess between the steps.

5. The indexing plunger according to claim 4, wherein a spring is clamped between an upper side of the magnet and the step.

6. The indexing plunger according to claim 4, wherein an elastomeric element is clamped between an upper side of the magnet and the step.

7. The indexing plunger according to claim 4, wherein the cavity is composed of an upper chamber facing the actuating end and a lower chamber facing the locking end.

8. The indexing plunger according to claim 7, wherein the chamber is smaller in diameter than the chamber and in that the transition between the chamber and the chamber is formed by a step.

9. The indexing plunger according to claim 1, further comprising a spring resting on a shoulder of the plunger the spring being compressible between the shoulder and the step inside the pin guide 3 below the chamber.

10. The indexing plunger according to claim 7, wherein the magnet comes to rest against the step during movement into the first axial end position facing the actuating end.

11. The indexing plunger according to any of claim 4, wherein the magnet comes to rest against the step during movement into the second axial end position facing the locking end.

12. The indexing plunger according to claim 1, wherein the magnet surrounds the pin in a annular or segment-like manner.

13. The indexing plunger according to claim 4, wherein the pin guide with the cavity is designed as a two-part assembly and consists of an upper housing and a lower housing.

14. The indexing plunger according to claim 13, wherein the two housing parts are connected to one another by means of a threaded connection, a press fit or by laser welding.

15. The indexing plunger according to claim 1, wherein the pin is held at one or both end positions by latching mechanisms, friction or adhesion.
